(19) United States
(12) Patent Application Publication
(10) Pub. No.: US 2010/0063707 A1
(43) Pub. Date: Mar. 11, 2010

(54) CONTROL METHOD AND DEVICE FOR A THERMAL ENGINE

(76) Inventor: Chin-Kuang Luo, Taichung City (TW)

Correspondence Address: FROMMER LAWRENCE & HAUG LLP, 745 FIFTH AVENUE, NEW YORK, NY, 10151, US

(21) Appl. No.: 12/269,367

(22) Filed: Nov. 12, 2008

(30) Foreign Application Priority Data
Sep. 5, 2008 (TW) 097134150

(51) Int. Cl. F02D 45/00

(52) U.S. Cl. 701/102; 123/435

(57) ABSTRACT

A control device for a thermal engine includes: a thermal energy generator for generating thermal energy through combustion of air and fuel supplied thereto and adapted for supplying the thermal energy to the thermal engine such that the thermal engine is driven to generate a mechanical power output; a flow control device coupled to the thermal energy generator and operable to control amounts of the air and the fuel supplied to the thermal energy generator; and a control unit for controlling the flow control device to adjust the amounts of the air and the fuel supplied to the thermal energy generator based on an operating parameter of the thermal engine. A control method for the thermal engine is also disclosed.

### CROSS-REFERENCE TO RELATED APPLICATION

This application claims priority of Taiwanese Application No. 097134150 filed on Sep. 5, 2008.

### BACKGROUND OF THE INVENTION

1. Field of the Invention

The invention relates to a control method and device for a thermal engine.

2. Description of the Related Art

FIG. 1 illustrates a conventional thermal engine 1 disclosed in U.S. Pat. No. 6,779,341 and including a first pneumatic cylinder 11, a second pneumatic cylinder 12, a fluid pipe 14 intercommunicating fluidly the first and second pneumatic cylinders 11, 12, and a flywheel assembly 13 coupled to the first and second pneumatic cylinders 11, 12. Thermal energy from a thermal energy source 2 is applied to a cylinder body 111 of the first pneumatic cylinder 11 to result in an expansion stroke of the first pneumatic cylinder 11 and in rotation of the flywheel assembly 13. The expansion stroke of the first pneumatic cylinder 11 also results in a compression stroke of the second pneumatic cylinder 12. When the first pneumatic cylinder 11 reaches the end of the expansion stoke, due to the presence of the fluid pipe 14, temperature of working gas in the first pneumatic cylinder 11 is reduced, while temperature of working gas in the second pneumatic cylinder 12 is increased, thereby resulting in an expansion stoke of the second pneumatic cylinder 12 and in continued rotation of the flywheel assembly 13. Similarly, the expansion stoke of the second pneumatic cylinder 12 results in a compression stoke of the first pneumatic cylinder 11. Accordingly, continuous rotation of the flywheel assembly 13 is achieved.

In such a configuration, a mechanical power output generated by the conventional thermal engine 1 depends on the thermal energy applied to the cylinder body 111 of the first pneumatic cylinder 11. Therefore, unstable supply of the thermal energy to the first pneumatic cylinder 11 results in unstable mechanical power output generated by the conventional thermal engine 1.

### SUMMARY OF THE INVENTION

Therefore, an object of the present invention is to provide a control method and device for a thermal engine that can ensure a stable mechanical power output generated by the thermal engine.

According to one aspect of the present invention, there is provided a control method for a thermal engine. The control method comprises the steps of:

a) detecting an operating parameter of the thermal engine;

b) comparing the operating parameter detected in step a) with a predetermined range; and

c) adjusting an amount of thermal energy supplied to the thermal engine based on result of comparison made in step b).

According to another aspect of the present invention, there is provided a control method for a thermal engine. The control method comprises the steps of:

a) generating thermal energy through combustion of air and fuel, and supplying the thermal energy to the thermal engine such that the thermal engine is driven to generate a mechanical power output; and

b) adjusting amounts of the air and the fuel for combustion based on an operating parameter of the thermal engine.

According to a further aspect of the present invention, there is provided a control device for a thermal engine. The control device comprises:

a thermal energy generator for generating thermal energy through combustion of air and fuel supplied thereto and adapted for supplying the thermal energy to the thermal engine such that the thermal engine is driven to generate a mechanical power output;

a flow control device coupled to the thermal energy generator and operable to control amounts of the air and the fuel supplied to the thermal energy generator; and

a control unit for controlling the flow control device to adjust the amounts of the air and the fuel supplied to the thermal energy generator based on an operating parameter of the thermal engine.

### BRIEF DESCRIPTION OF THE DRAWINGS

Other features and advantages of the present invention will become apparent in the following detailed description of the preferred embodiment with reference to the accompanying drawings, of which:

FIG. 1 is a partly sectional, schematic top view showing a conventional thermal engine disclosed in U.S. Pat. No. 6,779,341;

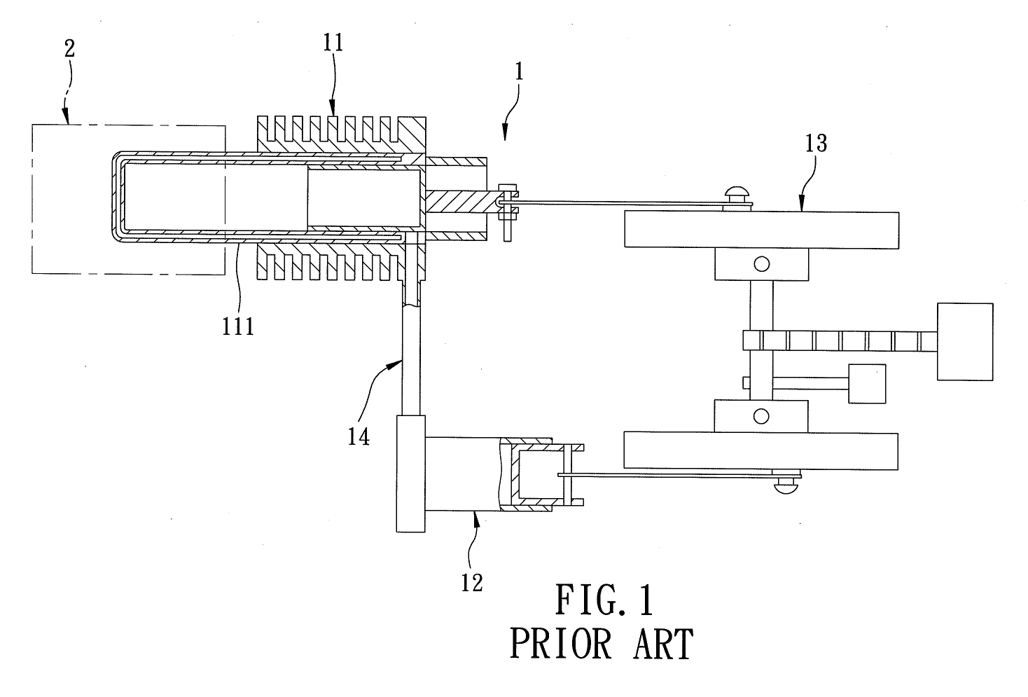

FIG. 2 is a schematic circuit block diagram showing the preferred embodiment of a control device for a thermal engine according to the present invention; and

FIG. 3 is a flow chart illustrating a control method for the thermal engine performed by the control device of the preferred embodiment.

### DETAILED DESCRIPTION OF THE PREFERRED EMBODIMENT

According to the present invention, a thermal engine can be controlled by detecting an operating parameter of the thermal engine, comparing the detected operating parameter with a predetermined range, and adjusting an amount of thermal energy supplied to the thermal engine based on result of comparison, wherein the thermal energy supplied to the thermal engine can be acquired from combustion of air and fuel, terrestrial heat or solar energy, and wherein the operating parameter of the thermal engine can be a temperature of the thermal engine and/or a mechanical power output generated by the thermal engine.

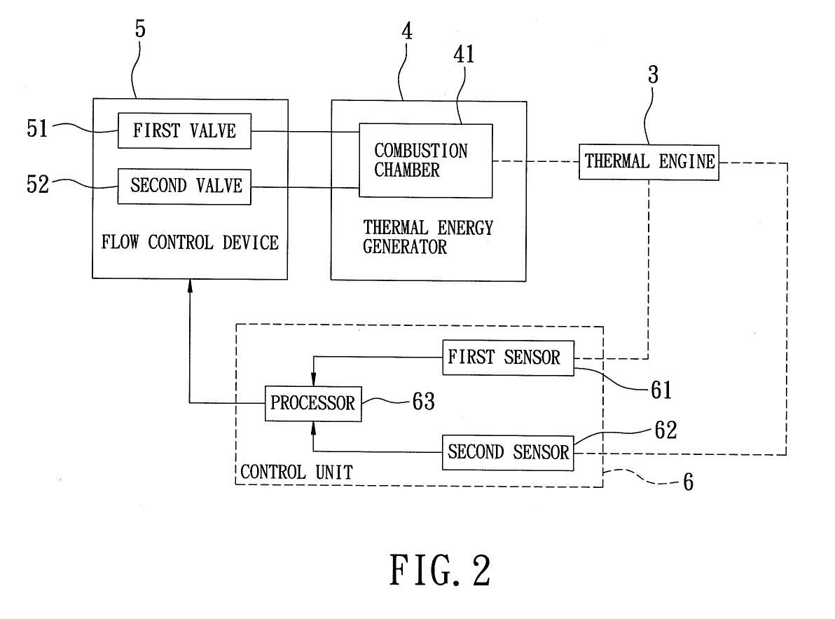

Referring to FIG. 2, the preferred embodiment of a control device for a thermal engine 3 according to the present invention is shown to include a thermal energy generator 4, a flow control device 5, and a control unit 6.

The thermal energy generator 4 generates thermal energy through combustion of air and fuel supplied thereto, and is adapted for supplying the thermal energy to the thermal engine 3 such that the thermal engine 3 is driven to generate a mechanical power output. In this embodiment, the thermal energy generator 4 includes a known combustion chamber 41 adapted to be in thermal contact with the thermal engine 3, receiving the air and the fuel, and adapted for combustion of the air and the fuel received therein to generate the thermal energy.

The flow control device 5 is coupled to the thermal energy generator 4, and is operable to control amounts of the air and the fuel supplied to the combustion chamber 41 of the thermal energy generator 4. In this embodiment, the flow control device 5 includes a first valve 51 and a second valve 52. The first valve 51 is in spatial communication with the combustion chamber 41 of the thermal energy generator 4, and is operable to control the amount of the air supplied to the combustion chamber 41. The second valve 52 is in spatial communication with the combustion chamber 41 of the thermal energy generator 4, and is operable to control the amount of the fuel supplied to the combustion chamber 41.

The control unit 6 controls the flow control device 5 to adjust the amounts of the air and the fuel supplied to the combustion chamber 41 of the thermal energy generator 4 based on the operating parameter of the thermal engine 3. In this embodiment, the operating parameter of the thermal engine 3 includes the mechanical power output generated by the thermal engine 3 and the temperature of the thermal engine 3. The control unit 6 includes a first sensor 61, a second sensor 62 and a processor 63. The first sensor 61 generates a first sensing signal indicative of the temperature of the thermal engine 3. The second sensor 62 generates a second sensing signal indicative of the mechanical power output generated by the thermal engine 3. The processor 63 is coupled to the first sensor 61, the second sensor 62 and the flow control device 5, and receives the first and second sensing signals from the first and second sensors 61, 62. The processor 63 controls the first and second valves 51, 52 of the flow control device 5, based on the first and second sensing signals from the first and second sensors 61, 62, to increase the amounts of the air and the fuel supplied to the combustion chamber 41 upon detecting that at least one of the mechanical power output generated by the thermal engine 3 and the temperature of the thermal engine 3 is less than a lower limit value of a corresponding one of a predetermined power output range and a predetermined temperature range, and to decrease the amounts of the air and the fuel supplied to the combustion chamber 41 upon detecting that at least one of the mechanical power output generated by the thermal engine 3 and the temperature of the thermal engine 3 is greater than an upper limit value of the corresponding one of the predetermined power output range and the predetermined temperature range.

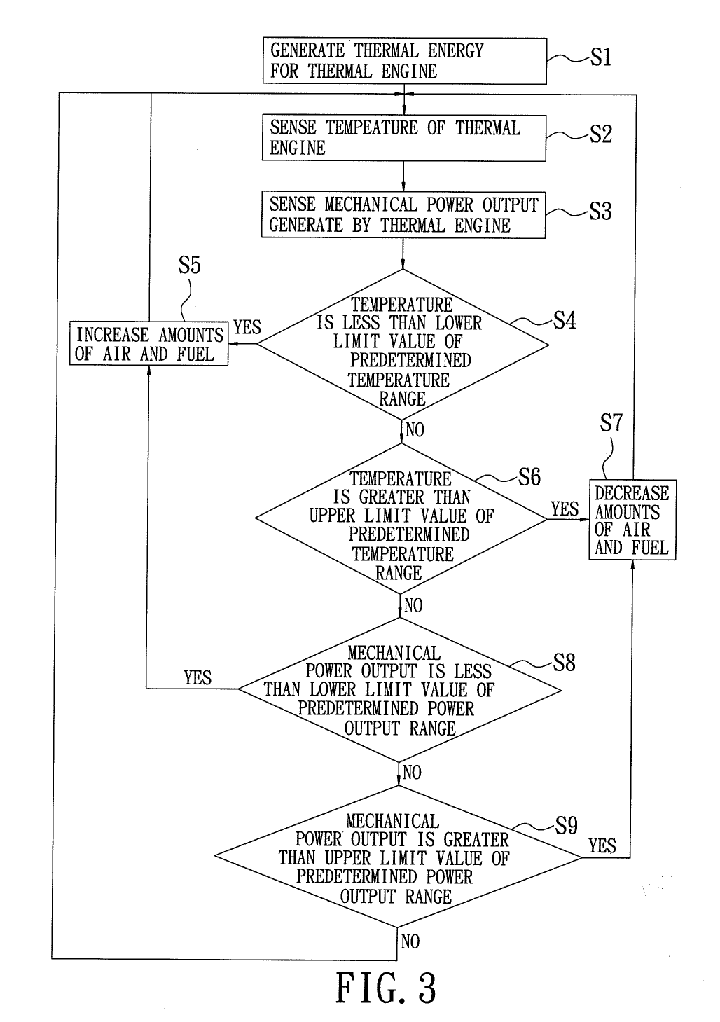

FIG. 3 is a flow chart a control method for the thermal engine 3 performed by the control device of the preferred embodiment.

In step S1, the thermal energy generator 4 generates the thermal energy through combustion of the air and the fuel received in the combustion chamber 41, and supplies the thermal energy to the thermal engine 3 such that the thermal engine 3 generates the mechanical power output. In step S2, the first sensor 61 of the control unit 6 senses the temperature of the thermal engine 3 to generate the first sensing signal. In step S3, the second sensor 62 of the control unit 6 senses the mechanical power output generated by the thermal engine 3 to generate the second sensing signal. In step S4, the processor 63 determines whether the temperature of the thermal engine 3 is less than the lower limit value of the predetermined temperature range based on the first sensing signal from the first sensor 61. If affirmative, the flow goes to step S5. Otherwise, the flow goes to step S6. In step S5, the processor 63 controls the first and second valves 51, 52 to increase the amounts of the air and the fuel supplied to the combustion chamber 41, and then the flow goes back to step S2. In step S6, the processor 63 determines whether the temperature of the thermal engine 3 is greater than the upper limit value of the predetermined temperature range based on the first sensing signal from the first sensor 61. If affirmative, the flow goes to step S7. Otherwise, the flow goes to step S8. In step S7, the processor 63 controls the first and second valves 51, 52 to decrease the amounts of the air and the fuel supplied to the combustion chamber 41, and then the flow goes back to step S2. Instep S8, the processor 63 determines whether the mechanical power output generated by the thermal engine 3 is less than the lower limit value of the predetermined power output range based on the second sensing signal from the second sensor 62. If affirmative, the flow goes back to step S5. Otherwise, the flow goes to step S9. In step S9, the processor 63 determines whether the mechanical power output generated by the thermal engine 3 is greater than the upper limit value of the predetermined power output range based on the second sensing signal from the second sensor 62. If affirmative, the flow goes back to step S7. Otherwise, the flow goes back to step S2.

Since the amounts of the air and the fuel supplied to the combustion chamber 41 can be appropriately adjusted by the control unit 6, through control of the first and second valves 51, 52, the control device of the present invention can ensure a stable mechanical power output generated by the thermal engine 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A control method for a thermal engine, comprising the steps of:
a) detecting an operating parameter of the thermal engine;
b) comparing the operating parameter detected in step a) with a predetermined range; and
c) adjusting an amount of thermal energy supplied to the thermal engine based on result of comparison made in step b).

2. The control method as claimed in claim 1, wherein the operating parameter detected in step a) is a temperature of the thermal engine, and the predetermined range is a predetermined temperature range.

3. The control method as claimed in claim 2, wherein step c) is performed only when the temperature of the thermal engine falls outside the predetermined temperature range.

4. The control method as claimed in claim 1, wherein the operating parameter detected in step a) is a mechanical power output generated by the thermal engine, and the predetermined range is a predetermined power output range.

5. The control method as claimed in claim 4, wherein step c) is performed only when the mechanical power output falls outside the predetermined power output range.

6. The control method as claimed in claim 1, wherein the operating parameter includes a temperature of the thermal engine and a mechanical power output generated by the thermal engine, the temperature of the thermal engine detected in step a) being compared with a predetermined temperature range in step b), the mechanical power output detected in step a) being compared with a predetermined power output range in step b).

7. A control method for a thermal engine, comprising the steps of:
a) generating thermal energy through combustion of air and fuel, and supplying the thermal energy to the thermal engine such that the thermal engine is driven to generate a mechanical power output; and
b) adjusting amounts of the air and the fuel for combustion based on an operating parameter of the thermal engine.

8. The control method as claimed in claim 7, wherein step b) includes the sub-steps of:
b-1) sensing a temperature of the thermal engine;
b-2) sensing a mechanical power output generated by the thermal engine;
b-3) increasing the amounts of the air and the fuel for combustion when at least one of the mechanical power output generated by the thermal engine and the temperature of the thermal engine is less than a lower limit value of a corresponding one of a predetermined power output range and a predetermined temperature range; and
b-4) decreasing the amounts of the air and the fuel for combustion when at least one of the mechanical power output generated by the thermal engine and the temperature of the thermal engine is greater than an upper limit value of the corresponding one of the predetermined power output range and the predetermined temperature range.

9. A control device for a thermal engine, comprising:
a thermal energy generator for generating thermal energy through combustion of air and fuel supplied thereto and adapted for supplying the thermal energy to the thermal engine such that the thermal engine is driven to generate a mechanical power output;
a flow control device coupled to said thermal energy generator and operable to control amounts of the air and the fuel supplied to said thermal energy generator; and
a control unit for controlling said flow control device to adjust the amounts of the air and the fuel supplied to said thermal energy generator based on an operating parameter of the thermal engine.

10. The control device as claimed in claim 9, wherein said thermal energy generator includes a combustion chamber adapted to be in thermal contact with the thermal engine, receiving the air and the fuel from said flow control device, and adapted for combustion of the air and the fuel received therein to generate the thermal energy.

11. The control device as claimed in claim 10, wherein said flow control device includes:
a first valve in spatial communication with said combustion chamber of said thermal energy generator and operable to control the amount of the air supplied to said combustion chamber; and
a second valve in spatial communication with said combustion chamber of said thermal energy generator and operable to control the amount of the fuel supplied to said combustion chamber.

12. The control device as claimed in claim 11, wherein:
the operating parameter is a temperature of the thermal engine; and
said control unit includes
a sensor for generating a sensing signal indicative of the temperature of the thermal engine, and
a processor coupled to said sensor and said flow control device, and receiving the sensing signal from said sensor, said processor controlling said first and second valves of said flow control device, based on the sensing signal from said sensor, to increase the amounts of the air and the fuel supplied to said combustion chamber of said thermal energy generator upon detecting that the temperature of the thermal engine is less than a lower limit value of a predetermined temperature range, and to decrease the amounts of the air and the fuel supplied to said combustion chamber of said thermal energy generator upon detecting that the temperature of the thermal engine is greater than an upper limit value of the predetermined temperature range.

13. The control device as claimed in claim 11, wherein:
the operating parameter is a mechanical power output of the thermal engine; and
said control unit includes
a sensor for generating a sensing signal indicative of the mechanical power output generated by the thermal engine, and
a processor coupled to said sensor and said flow control device, and receiving the sensing signal from said sensor, said processor controlling said first and second valves of said flow control device, based on the sensing signal from said sensor, to increase the amounts of the air and the fuel supplied to said combustion chamber of said thermal energy generator upon detecting that the mechanical power output generated by the thermal engine is less than a lower limit value of a predetermined power output range, and to decrease the amounts of the air and the fuel supplied to said combustion chamber of said thermal energy generator upon detecting that the mechanical power output generated by the thermal engine is greater than an upper limit value of the predetermined power output range.

14. The control device as claimed in claim 11, wherein:
the operating parameter of the thermal engine includes a temperature of the thermal energy and a mechanical power output generated by the thermal engine; and
said control unit includes
a first sensor for generating a first sensing signal indicative of the temperature of the thermal engine,
a second sensor for generating a second sensing signal indicative of the mechanical power output generated by the thermal engine, and
a processor coupled to said first sensor, said second sensor and said flow control device, and receiving the first and second sensing signals from said first and second sensors, said processor controlling said first and second valves of said flow control device, based on the first and sensing signals from said first and second sensors, to increase the amounts of the air and the fuel supplied to said combustion chamber of said thermal energy generator upon detecting that at least one of the mechanical power output generated by the thermal engine and the temperature of the thermal engine is less than a lower limit value of a corresponding one of a predetermined power output range and a predetermined temperature range, and to decrease the amounts of the air and the fuel supplied to said combustion chamber of said thermal energy generator upon detecting that at least one of the mechanical power output generated by the thermal engine and the temperature of the thermal engine is greater than an upper limit value of the corresponding one of the predetermined power output range and the predetermined temperature range.
